(19) United States
(12) Patent Application Publication
(10) Pub. No.: US 2003/0145476 A1
(43) Pub. Date: Aug. 7, 2003

(54) Drafting tool

(76) Inventor: Kun-Chen Chen, Taichung Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/072,035

(22) Filed: Feb. 7, 2002

(51) Int. Cl. G01B 3/04; B43L 7/00

(52) U.S. Cl. 33/484

(57) ABSTRACT

A drafting tool consists of a ruler body (10) and multiple auxiliary elements such as pen-guides, levels, gauges, tool holders, etc. attached to the ruler body to make the drafting tool handy to use.

### BACKGROUND OF THE INVENTION

1. Field of the Invention

The present invention relates to a drafting tool, and more particularly to a drafting tool for architecture, which is convenient to use.

2. Description of Related Art

A conventional ruler used to measure has a simple structure and does not have other functions to assist a user work conveniently. For example, the ruler can only be used to make a straight line, but cannot conveniently make a straight and horizontal line by itself. Therefore, the user can not draw an exactly horizontal or vertical line without other assistance like using plummet or similar at the same time, such that making the straight and horizontal lines is troublesome.

The present invention has arisen to mitigate and/or obviate the disadvantage of the conventional ruler.

### SUMMARY OF THE INVENTION

The main objective of the invention is to provide a drafting tool that has multiple auxiliary devices on a ruler body to make the drafting tool convenient to use.

Other advantages and novel features of the invention will become more apparent from the following detailed description when taken in conjunction with the accompanying drawings.

### BRIEF DESCRIPTION OF THE DRAWINGS

FIG. 1 is a perspective view of a drafting tool in accordance with the present invention;

FIG. 2 is a segmented exploded perspective view of the drafting tool as shown in FIG. 1;

FIG. 3 is a cross-sectional side plan view of the drafting tool along line 3-3 in FIG. 1; and

FIG. 4 is an operational perspective view of the drafting tool in FIG. 1.

### DETAILED DESCRIPTION OF THE PREFERRED EMBODIMENT

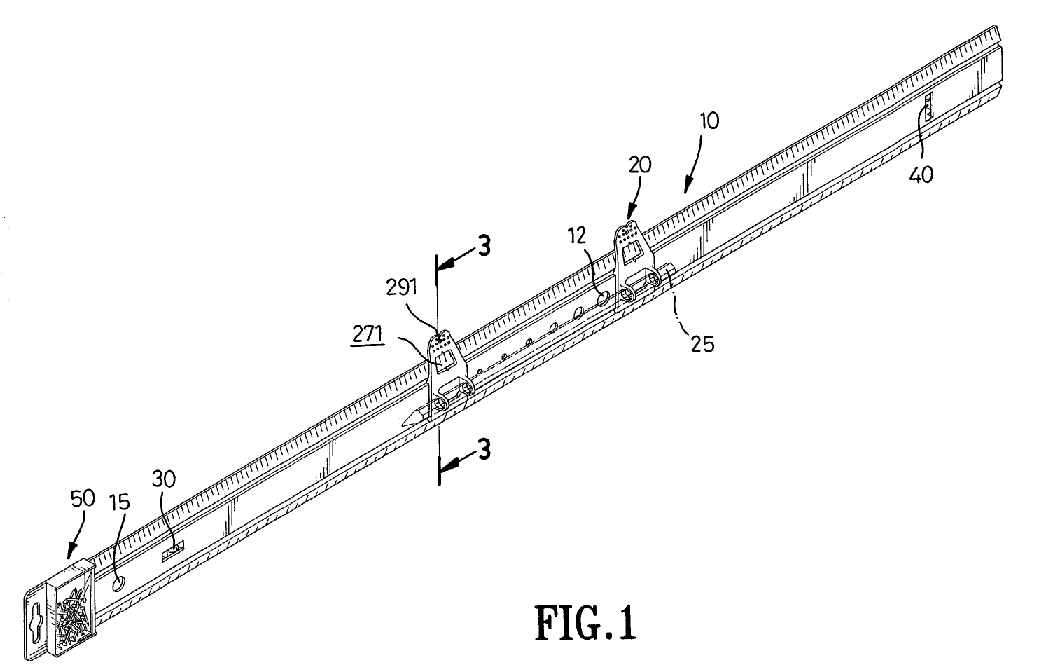

With reference to the FIGURES and initially to FIG. 1, a drafting tool in accordance with the present invention is composed of a ruler body (10), at least one pen-guide (20), a horizontal level (30), a vertical level (40) and a tool holder (50).

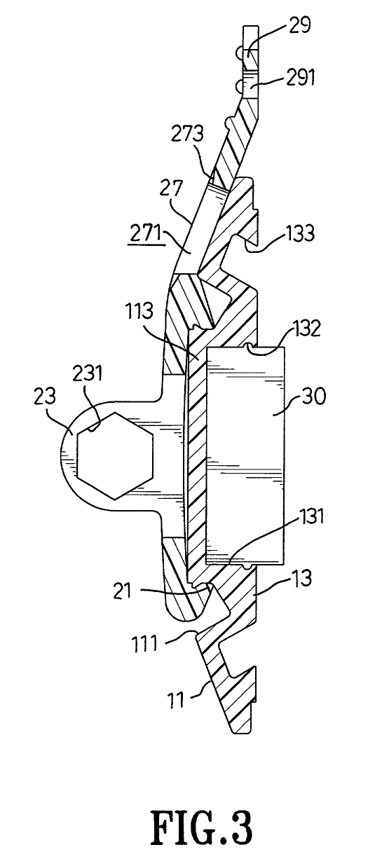

With reference to FIGS. 1 and 3, the ruler body (10) is a long strip with two parallel long edges and has a top face (11) and a bottom face (13). The top face (11) has two parallel guide grooves (111) defined longitudinally along the ruler body (10), which define a track (113) between the guide grooves (111) on the top face (11). The bottom face (13) has a longitudinal slot (131) defined in a middle portion of the bottom face (13) under the track (113). The longitudinal slot (131) has a detent slot (132) defined in each side of the longitudinal slot (131). Additionally, a longitudinal groove (133) is defined under each top face (11). Two different scales are respectively marked on the top of opposite long edges of the ruler body (10) for measuring. A series of circle gauges (12) is defined in the track (113) of the ruler body (10) so the user is able to draw a circle of a desired size. Furthermore, a locking hole (15) is defined in one end of the ruler body (10).

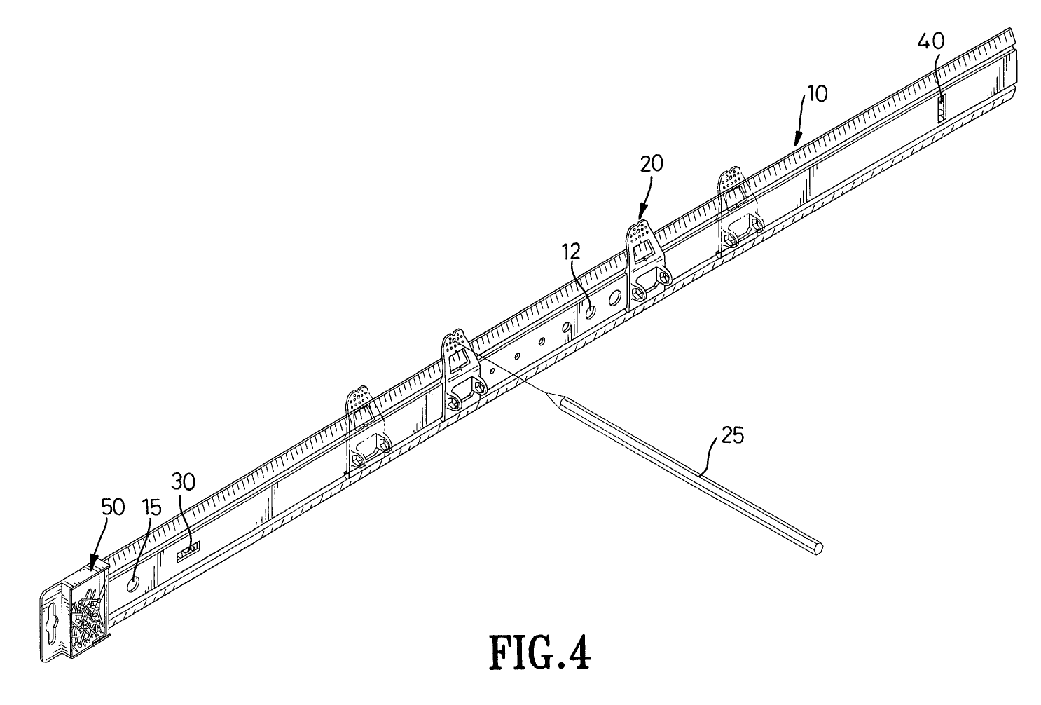

Two pen-guides (20) are slidably mounted on the top face (11) of the ruler body (10). Each pen-guide (20) has two opposed lips (21) protruding toward the ruler body (10), which clip onto the track (113) in the guide grooves (111) so the pen-guide (20) can slidably attach to the ruler body (10). A pair of ears (23) are formed on and extend perpendicular out from the pen-guide (20). A through hole (231) is defined in each of the ears (23) to hold a pen (25) on the drafting tool. All through holes (231) in the ears (23) are aligned in a line. A template arm (27) extends outward along the top face (11) of the ruler body (10), and a flat drawing template (29) is formed on a distal end of the template arm (27) beyond one edge of the ruler body (10). A window (271) is defined in the template arm (27) so the scales marked on the top face of the ruler body (10) can be viewed. An index (273) is formed on an exterior edge of the window (271), and a template hole (291) is defined in the flat drawing template (29). With further reference to FIG. 4, the template hole (291) is aligned with the index (273) in the window (271) so the user can mark position with desired separation by using the template hole (291) in adjacent pen guides (20).

The horizontal level (30) and the vertical level (40) are mounted on two opposite ends of the ruler body (10) under level windows (not numbered). By watching the appropriate level (30, 40) and adjusting the drafting tool, the drafting tool can be used to draw a horizontal line or a vertical line without other auxiliary equipment.

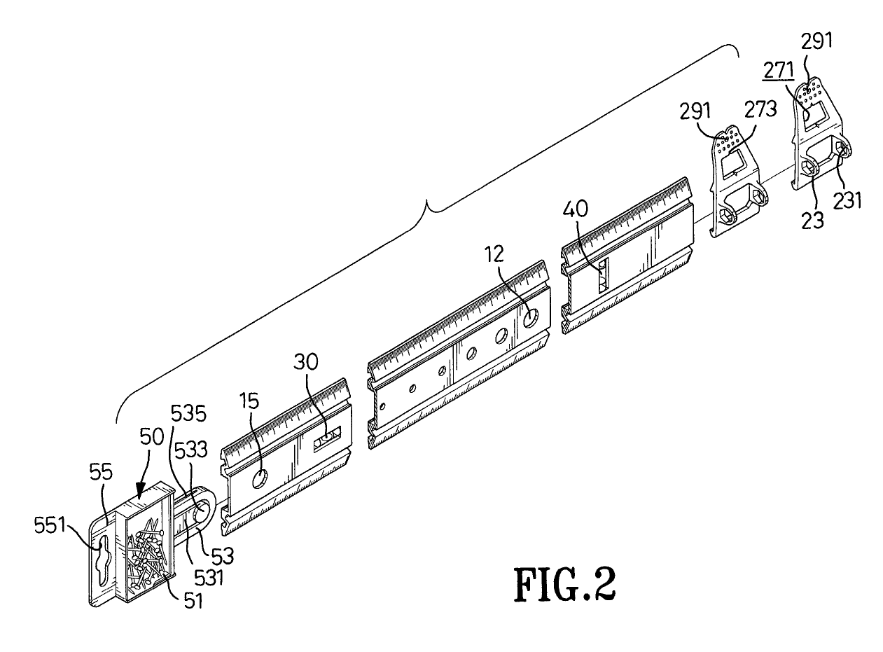

With reference to FIG. 2, the tool holder (50) is detachably mounted on one end of the ruler body (10) and comprises a compartment (51), a tongue (53) and a suspension tab (55). The compartment (51) has a lid (not numbered). The tongue (53) extends from the compartment (51) toward the ruler body (10). The suspension tab (55) is formed on the compartment (51) opposite to the tongue (53). The compartment (51) with a movable lid holds tools such as nails, screws or similar small items. The tongue (53) is a strip mounted in the longitudinal slot (131) in the ruler body (10). A resilient clamp strip (531) is formed inside the tongue (53) and has a raised button (533) formed on a distal end of the resilient clamp strip (531). The raised button (533) engages the locking hole (15) in the ruler body (10) to keep the tongue (53) from sliding out of the longitudinal slot (131). Two ribs (535) are formed on opposite edges of the tongue (53) to engage the detent slots (132) in the longitudinal slot (131) to hold the tongue (53) in the longitudinal slot (131) directly. The suspension tab (55) has a suspension hole (551) to allow the drafting tool to be suspended when the tongue (53) is mounted in the longitudinal slot (131) in the ruler body (10). However, the tool holder (50) can be detached by pressing the button (533) out of the locking hole (15) and pulling the tongue (53) out of the longitudinal slot (131) in the ruler body (10).

Based on the foregoing description, it is easy to be understood that the drafting tool has multiple auxiliary functions when used with other useful objects such as pens, nails or levels to make the drafting tool convenient to use.

It should be clear to those skilled in the art that further embodiments may be made without departing from the scope and spirit of the present invention. Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A drafting tool comprising:
a ruler body (10) with a top face (11) having scales and a bottom face (13), and the ruler body having:
two guide grooves (111) defined in the top face of the ruler body (10) in parallel;
a track (113) formed between the guide grooves (111) in the top face; and
a longitudinal slot (131) longitudinally defined in the bottom face (13) under the track (113);
at least one pen-guide (20) slidably mounted in the guide grooves (111) in the top face (11) of the ruler body (10), each pen-guide (20) having:
a pair of lips (21) detachably clipping onto the track (113) of the ruler body (10);
a pair of ears (23) formed on and perpendicular to the pen-guide (20) and adapted to hold a pen;
a template arm (27) extending outward along the top face (11) of the ruler body (10) and having a window (271) through which the scales on the top face of the ruler body (10) are viewed; and
a flat drawing template (29) formed on a distal edge of the template arm (27) and having a template hole (291) defined in the flat drawing template (29) for marking;
a horizontal level (30) movably mounted on the bottom of the ruler body (10) under a window;
a vertical level (40) movably mounted on the bottom of the ruler body (10) under a window; and
a tool holder (50) detachably secured on one end of the ruler body (10) and having:
a compartment (51) with a lid;
a tongue (53) extending from the compartment (51) to engage the longitudinal slot (131) in the ruler body (10); and
a suspension tab (55) formed on the compartment (51) opposite to the tongue (53) with a suspension hole (551) defined in the suspension tab (55).

2. The drafting tool as claimed in claim 1, wherein the longitudinal slot (131) further has two detent slots (132) respectively defined in two opposite inner walls of the longitudinal slot (131); and
the tongue (53) further has two ribs (535) formed on opposite edges of the tongue (53) to engage the detent slots (132) in the longitudinal slot (131) to hold the tongue (53) in the longitudinal slot (131) directly.

3. The drafting tool as claimed in claim 1, in which a series of circle gauges (12) is defined in the track (113) of the ruler body (10) so the user is able to draw a circle of a desired size.

4. The drafting tool as claimed in claim 1, the tongue (53) further has a resilient clamp strip (531) formed inside the tongue (53) and has a button (533) formed on a distal end of the resilient clamp strip (531);
the ruler body (10) further has a locking hole (15) defined in one end of the ruler body (10) to engage the button (533) on the tongue to detachably lock the tool holder (50) on the ruler body.

5. The drafting tool as claimed in claim 2, the tongue (53) further has a resilient clamp strip (531) formed inside the tongue (53) and has a button (533) formed on a distal end of the resilient clamp strip (531); and
the ruler body (10) further has a locking hole (15) defined in one end of the ruler body (10) to engage the button (533) of the tongue to detachably lock the tool holder (50) on the ruler body.

6. The drafting tool as claimed in claim 1, wherein the suspension tab (55) further has a suspension hole (551) for suspension.

7. The drafting tool as claimed in claim 1, wherein a through hole (231) is defined in each of the ears (23) to hold a pen (25) and all through holes (231) of each ears (23) are aligned in a line.

8. The drafting tool as claimed in claim 1, wherein the window (271) has an index (273) formed on an edge of the window (271) and aligned with the template hole (291) to allow precise marking via the template hole (291).
